(19) United States
(12) Patent Application Publication
(10) Pub. No.: US 2011/0128243 A1
(43) Pub. Date: Jun. 2, 2011

(54) INFORMATION PROCESSING APPARATUS AND IDENTIFICATION METHOD OF INFORMATION PROCESSING APPARATUS

(75) Inventor: Masaki Murakoshi, Akishima-shi (JP)

(73) Assignee: KABUSHIKI KAISHA TOSHIBA, Tokyo (JP)

(21) Appl. No.: 12/942,708

(22) Filed: Nov. 9, 2010

(30) Foreign Application Priority Data
Nov. 30, 2009 (JP) 2009-272633

(51) Int. Cl. G06F 3/041

(52) U.S. Cl. 345/173

(57) ABSTRACT

According to one embodiment, an information processing apparatus includes a display device with a multitouch touchpanel, an identification module, an object display module and a determination module. The identification module is configured to identify an operator by means of a touch operation on the multitouch touchpanel. The object display module is configured to display an object used to indicate n regions capable of accepting the identification touch operation on a screen of the display device. The determination module is configured to accept the identification touch operation on at least one of n regions on the multitouch touchpanel corresponding to the n regions capable of accepting identification touch operation m times, and to determine whether operator identification is succeeded based on whether the m identification touch operations agree with a touch operations registered in advance.

### CROSS-REFERENCE TO RELATED APPLICATIONS

This application is based upon and claims the benefit of priority from Japanese Patent Application No. 2009-272633, filed Nov. 30, 2009; the entire contents of which are incorporated herein by reference.

### BACKGROUND

1. Field

Embodiments described herein relate generally to an operator identification technique preferable for an information processing apparatus comprising a touch-sensitive display screen.

2. Description of Related Art

In recent years, various types of personal computers (PCs) have broadly been used, such as desktop types and notebook types. Generally, these kinds of PCs accept instructions from a user via operation of a keyboard, mouse, or the like. Recently, however, PCs capable of accepting instructions from a user by means of a touch operation on the display screen (using a finger or stylus) have begun to be prevalent.

While operator identification in PCs and the like is often performed by password input via a keyboard, various mechanisms have been proposed that perform operator identification by making the user perform a predetermined touch operation on a display screen (for example, see International Publication No. 03/079204).

Multitouch touchpanels, capable of sensing multiple points of touch simultaneously, have recently been released and have begun to be applied to PCs and the like in place of touchpanels (single-touch touchpanels) that sense only one point of touch at a time.

Conventional mechanism, including a password input device described in the International Publication No. 03/079204, for performing operator identification by causing the operator to perform a predetermined touch operation on a display screen is based on the premise that a single-touch touchpanel is used. Since a touch operation can be performed at only one portion in a single-touch touchpanel at a time as described above, there has been a problem that the password may be leaked through cheats or the like.

### SUMMARY

An information processing apparatus for identifying an operator or other user is disclosed. The apparatus comprises a display device with a multitouch touchpanel; an identification module configured to identify an operator by means of a touch operation on the multitouch touchpanel; an object display module configured to display an object used to indicate n regions capable of accepting identification touch operation on a screen of the display device, n being an integer; and a determination module configured to accept the identification touch operation on at least one of n regions on the multitouch touchpanel corresponding to the n regions capable of accepting identification touch operation m times, and to determine whether operator identification is successful based on whether at least some of the m identification touch operations agree with touch operations registered in advance, m being an integer.

Also disclosed is an information processing apparatus comprising n operation buttons, n being an integer; and an identification module configured to receive an operation of at least one of the n operation buttons, and to determine whether operator identification is succeeded based on whether m operations agree with an operation registered in advance, m being an integer.

Also disclosed is an identification method of an information processing apparatus comprising a display device with a multitouch touchpanel, the method comprising: displaying an object indicating n regions capable of accepting identification touch operation on a screen of the display device n being an integer; accepting an identification touch operation on at least one of n regions on the multitouch touchpanel corresponding to the n regions capable of accepting identification touch operation m times, m being an integer; and determining whether operator identification is successful based on whether the m identification touch operations agree with touch operations registered in advance.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary outer view of an information processing apparatus according to an embodiment.

FIG. 2 is an exemplary view illustrating a system configuration of the information processing apparatus according to the embodiment.

FIG. 3 an exemplary view illustrating an example of data sets indicating a registered password used in the information processing apparatus according to the embodiment.

FIG. 4 is an exemplary flowchart illustrating the procedure of an operator identification executed by the information processing apparatus according to the embodiment.

### DETAILED DESCRIPTION

Various embodiments will be described hereinafter with reference to the accompanying drawings.

In general, according to one embodiment, an information processing apparatus includes a display device with a multitouch touchpanel, an identification module, an object display module and a determination module. The identification module is configured to identify an operator by means of a touch operation on the multitouch touchpanel. The object display module is configured to display an object used to indicate n regions capable of accepting the identification touch operation on a screen of the display device. The determination module is configured to accept the identification touch operation on at least one of n regions on the multitouch touchpanel corresponding to the n regions capable of accepting identification touch operation m times, and to determine whether operator identification is succeeded based on whether the m identification touch operations agree with a touch operations registered in advance.

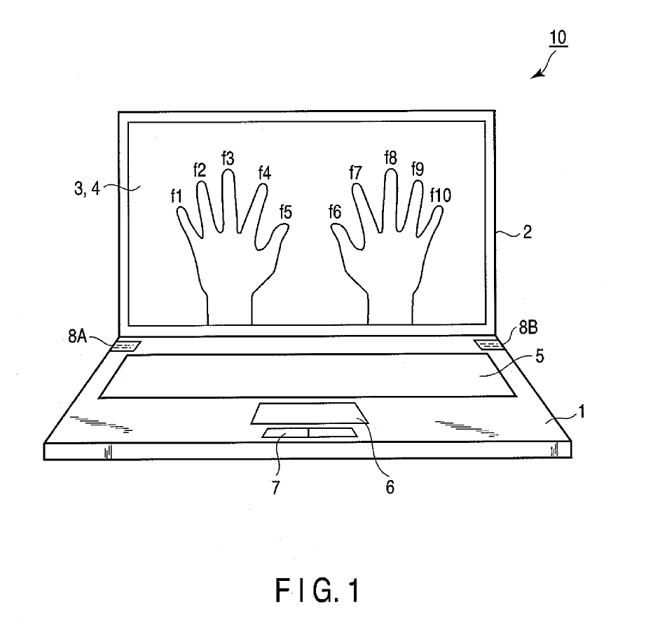

FIG. 1 shows an exemplary outer view of an information processing apparatus according to the embodiment. The information processing apparatus is embodied as a notebook PC (computer 10), for example.

As shown in FIG. 1, the computer 10 includes a computer body 1, and a display unit 2. The display unit 2 includes a liquid crystal display (LCD) 3 and a multitouch touchpanel 4, such that they are arranged over one another. The display unit 2 is rotatably attached to the computer body 1 between an open position, in which an upper surface of the display unit 1 is exposed, and a closed position, in which the upper surface of the display unit 2 is covered.

The computer body 1, to which the display unit 2 is rotatably attached, has a flat box-shaped housing. On an upper surface of the housing, there are arranged a keyboard 5, a touchpad 6, a mouse button 7, speakers 8A, 8B, and the like.

The computer 10 including the multitouch touchpanel with the above-described configuration includes a new operator identification mechanism. That is, the computer 10 displays a human hand shaped object as an operation guide on the LCD 3, as shown in FIG. 1, for example, causing the operator to perform a touch operation with at least one of the ten digits of both hands (preferably a touch operation with different digits every time), and thereby the operator is identified. This mechanism has improved the security level of operator identification by means of a touch operation on a touchpanel. Details about this will be described below. It is to be noted that the human hand shaped object shown in the LCD 3 as an operation guide is merely an example, and may be modified in various ways. For example, a clavier or keyboard shaped object may be displayed on the LCD 3 as an operation guide.

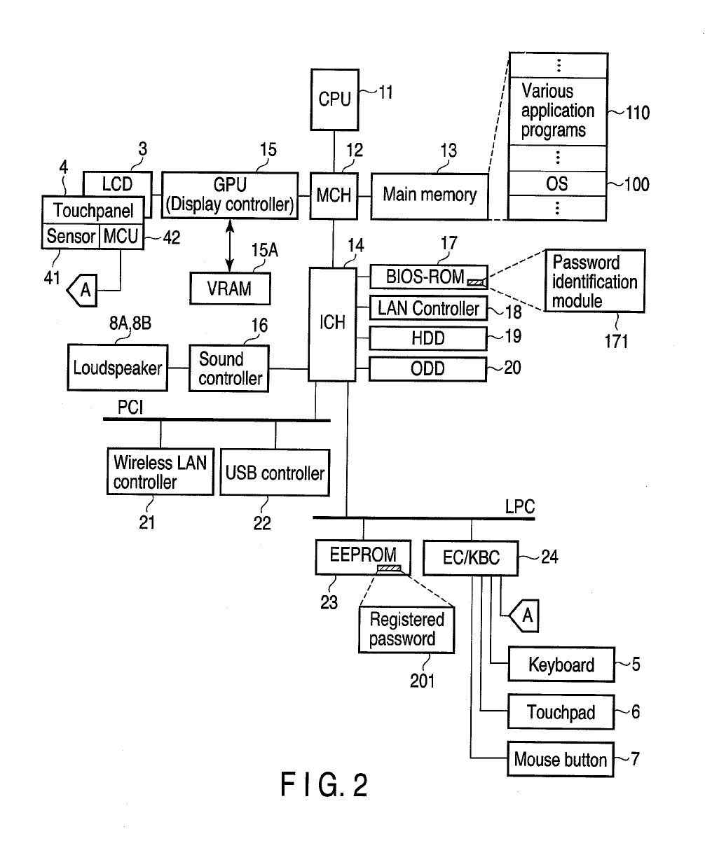

FIG. 2 illustrates a system configuration of the computer 10. As shown in FIG. 2, the computer 10 includes a central processing unit (CPU) 11, a memory controller hub (MCH) 12, a main memory 13, an input/output controller hub (ICH) 14, a graphics processing unit (GPU) 15, a video memory (VRAM) 15A, a sound controller 16, a Basic Input/Output System read-only memory (BIOS-ROM) 17, a local area network (LAN) controller 18, a hard disc drive (HDD) 19, an optical disc drive (ODD) 20, a wireless LAN controller 21, a Universal Serial Bus (USB) controller 22, an electrically erasable programmable ROM (EEPROM) 23, an embedded controller/keyboard controller (KBC) 24, and the like.

The CPU 11 is a processor configured to control the operation of the computer 10, and executes various programs loaded from the HDD 19 or the ODD 20 to the main memory 13. Such programs executed by the CPU 11 include the OS 100, which is in charge of resource management, and various applications 120, which operate under the control of the OS 100. Further, the CPU 11 also executes BIOS stored in the BIOS-ROM 17. The BIOS is a program for controlling hardware. The BIOS includes a password identification module 171, which will be described below.

While the MCH 12 operates as a bridge that connects the CPU 11 and the ICH 14, the MCH 12 also operates as a memory controller that controls access of the main memory 13. Further, the MCH 12 also includes a function of executing communications with the GPU 15.

The GPU 15 is a display controller configured to control the LCD 3 incorporated in the display unit 2. The GPU includes a VRAM 15A, which is a video memory, and an accelerator that depicts an image that various programs want to display in place of the CPU 11.

The ICH 14 controls various devices on a Peripheral Component Interconnect (PCI) bus and a Low Pin Count (LPC) bus. The ICH 14 includes an Integrated Device Electronics (IDE) controller integrated therein and configured to control the HDD 19 and the ODD 20. Further, the ICH 14 also includes a function of executing communications with the sound controller 16 and the LAN controller 18.

The sound controller 16 is a sound source device, and outputs audio data to be played back by various programs to a speaker and the like.

The LAN controller 18 is a wired communication device configured to execute wired communications complying with the IEEE 802.3 standard, for example. On the other hand, the wireless LAN controller 21 is a wireless communication device that performs wireless communications complying with the IEEE 802.11 standard, for example. Further, the USB controller 22 performs communications compliant with the USB 2.0 standard between an external device connected via a cable, for example.

The EEPROM 23 is a memory device configured to store identification information of the computer 10, for example. A registered password 201, which is used for password identification as will be described below, is stored in the EEPROM 23.

Further, the EC/KBC 24 is a one-chip microprocessor unit (MPU), in which an embedded controller for power management and a keyboard controller configured to control data input via the touchpanel 4, the key board 5, the touchpad 6, or the mouse button 7. As described above, the touchpanel provided over the LCD 3 is a multitouch touchpanel, and includes a sensor 41 and a microcontroller unit (MCU) 42. When a touch operation is performed in n portions on the touchpanel 4, all n portions are detected by the sensor 41, and positional information is output by the MCU 42. The positional information output by the MCU 42 is led to the EC/KBC 24. The EC/KBC 24 stores the positional information in its register, notifies the CPU 11 of the positional information by generating an interruption, and causes the CPU 11 to read the positional information stored in the register. Thereby, generation of the event, i.e., the touchpanel operation on the touchpanel 4, is transmitted to the BIOS or the OS 100, and the OS 100, for example, notifies the various applications 120 displaying screens on portions of the LCD 3 corresponding to the portions indicated by the positional information.

Here, the basic principle of the operator identification executed by the computer 10 will be described. The human hand shaped object shown in FIG. 1 is displayed on the LCD 3 by the password identification module 171 of the BIOS when the power is turned on.

In this case, assume that the reference numbers from f1 to f10 are assigned to the ten digits from the little finger of the left hand to the little finger of the right hand, respectively. Further, in this description, assume that a touch operation is performed at least 4 times by at least one of the ten digits.

First, the conventional case will be considered where a touch operation is performed by a single touch. In this case, a desired password can be selected and registered from among 10⁴ passwords, i.e., 10,000 passwords. Since all the four touch operations are performed by one of the ten digits, however, there still remains the possibility that the passwords may be leaked out by cheats.

Next, the case of the present embodiment will be considered where a touch operation is performed by a multi touch. In this case, assuming that a multitouch with up to two digits (including a single touch with a digit) is accepted, ((10×9)/(2×1)+10)⁴ passwords, i.e., 9,150,625 passwords can be set.

A detailed description will be given below, with regard to how to count the number of passwords that can be set. There are (10×9)/(2×1) ways of selecting two digits from ten. Further, there are ten ways of selecting one digit from ten. Accordingly, when multitouch with up to two digits is allowed, the number of characters (reference numbers from f1 to f10 in this case) that can be input at one time is obtained by ((10×9)/(2×1)+10). After the input is repeated four times, ((10×9)/(2×1)+10)⁴ passwords, i.e., 9,150,625 passwords can be set.

If multitouch with up to four digits is accepted, the number of passwords that can be set greatly increases to ((10×9×8×7)/(4×3×2×1)+(10×9×8)/(3×2×1)+(10×9)/(2×1)+10)⁴ passwords, i.e., 21,970,650,635.

A detailed description will be given below on how to count the number of passwords that can be set in the case where multitouch with up to four digits is accepted. There are ((10×9×8×7)/(4×3×2×1) ways of selecting four digits from ten. There are ((10×9×8)/(3×2×1)) ways of selecting three digits from ten. When multitouch with four digits is accepted, the number of characters that can be input at one time (reference numbers from f1 to f10 in this case) is ((10×9×8×7)/(4×3×2×1)+(10×9×8)/(3×2×1)+(10×9)/(2×1)+10. After this input is repeated four times, the number of passwords that can be set at one time is obtained by ((10×9×8×7)/(4×3×2×1)+(10×9×8)/(3×2×1)+(10×9)/(2×1)+10)⁴.

Since the touch operation is performed simultaneously with more than one digit, it is not likely to be identified through cheating which digit has performed the touch operation each of the four times.

The password identification module 171 displays the identification screen shown in FIG. 1 on the LCD 3 as a setting screen. The operator (valid user) repeats the multitouch with up to two digits, for example, four times. In this case, the touch operation by the operator is converted into numbers by assigning “1” to the digit that has performed (pressed) the touch operation and “0” to the digit that has not performed (pressed) the touch operation. The converted numbers are stored in the EEPROM 23 as a registered password 201.

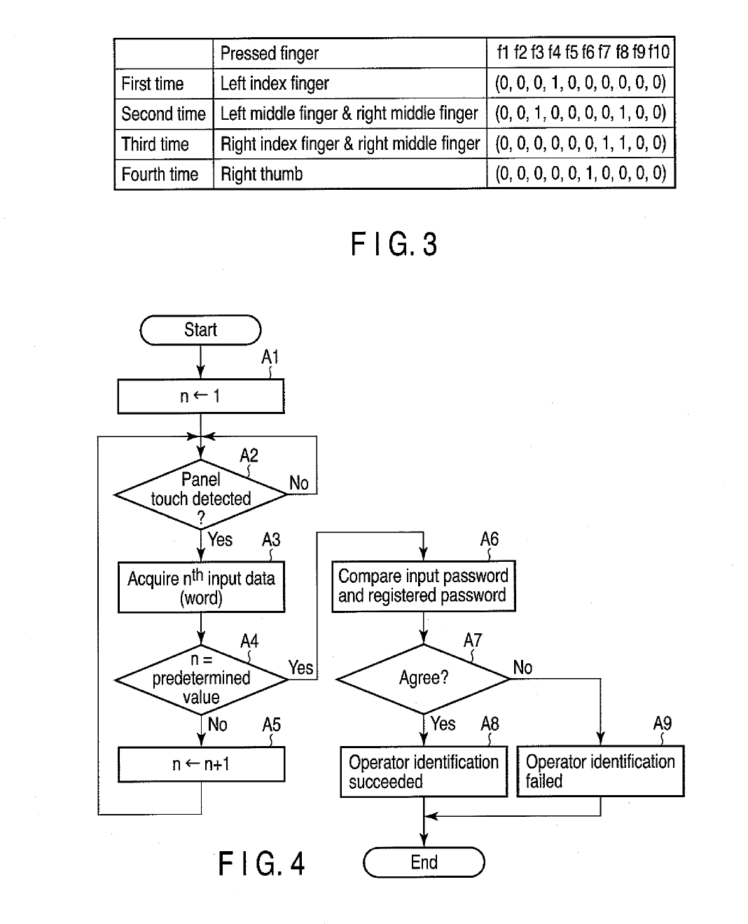

For example, the case will be considered where the operator performs (1) a single touch with the index finger of the left hand, (2) a multi touch with the middle finger of the left hand and the middle finger of the right hand, (3) a multi touch with the index finger of the right hand and the middle finger of the right hand, and (4) a single touch with the thumb of the right hand. In this case, as shown in FIG. 3, the password identification module 171 generates data sets of (0, 0, 0, 1, 0, 0, 0, 0, 0, 0), (0, 0, 1, 0, 0, 0, 0, 1, 0, 0), and (0, 0, 0, 0, 0, 0, 1, 1, 0, 0), (0, 0, 0, 0, 0, 1, 0, 0, 0, 0), and stores them as registered password 201. The password identification module 171 may separately provide a user interface that allows a user to set how many fingers can be accepted for the multitouch and how many times the multitouch can be repeated, and the content set by the user may be stored in the EEPROM 23.

When the computer 10 is powered on after the registered password 201 is stored in the EEPROM 23, the password identification module 171 displays the identification screen shown in FIG. 1 on the LCD 3. If the touch operation is performed four times by an operator, the password identification module 171 determines whether the operator is identified or not depending on whether the content of the touch operation agrees with the content indicated by the registered password 201. When the operator identification has been determined by the password identification module 171 as having succeeded, the BIOS starts activating the OS 100. When the operator identification has been determined as having failed, on the other hand, the computer 10 is compulsorily powered off, for example.

FIG. 4 is an exemplary flowchart illustrating the procedure for the operator identification executed by the computer 10.

The password identification module 171 initializes a counter indicating what number time the touch operation to be performed is to “1” (block A1), and waits for a touch operation to be performed by an operator (block A2). When a touch operation is performed by an operator, the password identification module 171 acquires input data (word) of the number of times indicated by the counter by assigning “1” to the digit that has performed (pressed) the touch operation and “0” to the digit that has not performed (pressed) the touch operation (block A3).

The password identification module 171 checks whether the value indicated by the counter agrees with a predetermined value (which is “4” when the touch operation is performed 4 times) (block A4). When the value indicated by the counter disagrees with the predetermined value (NO in block A4), the value of the counter is incremented by one time (block A5), and the process is repeated from block A2.

When the value indicated by the counter agrees with the predetermined value (YES in block A4), which means that the password input by the touch operation has been completed, the password identification module 171 compares the input password with the registered password 201 stored in the EEPROM (block A6). If they agree (YES in block A7), it is determined that the operator identification has succeeded (block A8). If they disagree (NO in block A8), it is determined that the operator identification has failed (block A9).

In this way, the computer 10 uses various combinations of digits as identification passwords, and thus provides improved security level, compared to the single-touch case. Further, since the touch operation is performed simultaneously with more than one digit, it is difficult to identify which digit has performed the touch operation through cheats. From this point, too, the security level is improved.

While the approach of the embodiment has been described above by taking the case where a multi touch is performed on the touchpanel 4 provided over the LCD 3 as an example, the approach of the embodiment is not limited thereto and can be modified in various ways. For example, more than one operation buttons may be provided, and passwords may be input by operating at least one of the operation buttons more than once.

Further, more than one keys on the keyboard 5 may be used instead as the operation buttons. When a key is pressed, the keyboard 5 outputs its key code. While the key is pressed, a return code is repeatedly output (in place of the key code). The key code indicating which key has been pressed can be output only one by one. However, a password can be in the same way as that of the multi touch on the touchpanel 4, by regarding the key indicated by the key code newly output while the return code is being output as having been pressed simultaneously with the key that is causing the return code to be output.

Further, the approach of the embodiment has been described above by taking a PC as an example, but the approach of the embodiment is not limited thereto, and may be applied to various electronic appliances, such as a portable phone equipped with a multitouch touchpanel, and an automated teller machine (ATM), for example.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display device with a multitouch touchpanel;
an identification module configured to identify an operator by means of a touch operation on the multitouch touchpanel;
an object display module configured to display an object used to indicate n regions capable of accepting identification touch operation on a screen of the display device, n being an integer; and
a determination module configured to accept the identification touch operation on at least one of n regions on the multitouch touchpanel corresponding to the n regions capable of accepting identification touch operation m times, and to determine whether operator identification is successful based on whether the m identification touch operations agree with touch operations registered in advance, m being an integer.

2. The apparatus of claim 1, wherein the object display module is configured to display a human hand shaped object on the screen of the display device, such that n digits are respectively arranged on the n regions capable of accepting the identification touch operation.

3. The apparatus of claim 2, wherein an identifier is displayed on or in the vicinity of each of the digits of the human hand shaped object.

4. The apparatus of claim 3, wherein the identifier comprises a number.

5. The apparatus of claim 1, wherein the object display module is configured to display a clavier-shaped object on the screen of the display device such that n keys are respectively arranged on the n regions capable of accepting the identification touch operation.

6. An information processing apparatus comprising:
n operation buttons, n being an integer; and
an identification module configured to receive an operation of at least one of the n operation buttons, and to determine whether operator identification is succeeded based on whether m operations agree with an operation registered in advance, m being an integer.

7. The apparatus of claim 6, further comprising a keyboard, wherein the n operation buttons are n keys on the keyboard.

8. An identification method of an information processing apparatus comprising a display device with a multitouch touchpanel, the method comprising:
displaying an object indicating n regions capable of accepting identification touch operation on a screen of the display device n being an integer;
accepting an identification touch operation on at least one of n regions on the multitouch touchpanel corresponding to the n regions capable of accepting identification touch operation m times, m being an integer; and
determining whether operator identification is successful based on whether the m identification touch operations agree with touch operations registered in advance.

9. The method of claim 8, wherein displaying the object comprises displaying a human hand shaped object on a screen of the display device, such that n digits are respectively arranged on the n regions capable of accepting the identification touch operation.

10. The method of claim 8, wherein the displaying the object comprises displaying a keyboard-shaped object on the screen of the display device, such that the n keys are respectively arranged on the n regions capable of accepting the identification touch operation.
